(19) United States
(12) Patent Application Publication
(10) Pub. No.: US 2021/0004796 A1
(43) Pub. Date: Jan. 7, 2021

(54) Graph Re-write Using Ghost Nodes for Target Value Rebalancing

(71) Applicants: Patrick B. Dugan, Philadelpiha, PA (US); Daniel P. Pizarro, Philadelphia, PA (US); Lihki J. Rubio, Philadelphia, PA (US)

(72) Inventors: Patrick B. Dugan, Philadelpiha, PA (US); Daniel P. Pizarro, Philadelphia, PA (US); Lihki J. Rubio, Philadelphia, PA (US)

(21) Appl. No.: 16/920,416

(22) Filed: Jul. 2, 2020

Related U.S. Application Data
(60) Provisional application No. 62/869,730, filed on Jul. 2, 2019.

(51) Int. Cl. G06Q 20/38; G06F 16/27; G06Q 20/06

(52) U.S. Cl. CPC G06Q 20/389; G06Q 20/0658; G06F 16/27

(57) ABSTRACT

Through blockchain technology, asymmetry that accumulates in a graph of connected parties as the number of nodes, vertices, and the difference between target value vs. vertex value increases, is systematically reduced by modeling a graph atomically to the level of each trade, sorting through sub-graphs, applying a ghost node extrapolative search, eliminating ghost node paths that don't result in zero-sum reduction of the graph, assembling a set of zero-sum sub-graphs, targeting a solution with closest-fit to an external target value, eliminating all nodes with more than one vertex, and reducing all nodes with one vertex to single pairs.

### CROSS-REFERENCE TO RELATED APPLICATIONS

This application claims the benefit of U.S. Provisional Application No. 62/869,730 filed on Jul. 2, 2019, the contents of which are incorporated by reference herein.

### FIELD OF THE INVENTION

The present invention relates to finance methodology, and, more particularly, the usage of ghost nodes for target value rebalancing within a blockchain network.

### BACKGROUND

What has traditionally been a finance methodology for the clearing of derivatives becomes, in a decentralized environment such as the Bitcoin protocol, a computer science problem: how to enable peer-to-peer derivatives to clear with no central clearinghouse. Solving this problem has significant applications for allowing a parallel financial system, permissionless hedging, and denomination of commodity-backed currency in various popular denominations such as EUR, USD, and JPY. In the field of decentralized financial technology, derivatives contracts proposed to date generally suffer from lack of structural tangibility in netting losing positions with off-setting trades. Models based on code executing in the Ethereum Virtual Machine take a simplistic approach to multilaterally updating balances and use fee revenue or other mechanisms to offset systemic risk. Models based on trapping Bitcoin value in multi-signature addresses and using Schnorr signatures to update trading information about that address, suffer from too much bilateralism, potential counterparty risk that poses an operational risk, and lack of capital efficiency with clearing.

The history of clearinghouses has involved the usage of netting and gridlock resolution algorithms, in correspondent banking, stock and derivatives clearinghouses, which enable truncation of chains of counterparties and closed positions, the utilization of deposited margin capital to offset other liabilities in the system, and an efficient limitation of the risk that these movements of value pose to the central party. To ameliorate the inefficiencies of these systems that can nonetheless accrue from high leverage and volatile markets, clearinghouses have reaped sources of revenue, leaned on credit facilities, and enforced increased margin requirements for clearing members. When global leverage and volatility proved too great to manage, additional capital was provided to the financial system from the top, to limit the risk of systemic failure from cascading chains of defaults. There is a rich body of academic and commercial intellectual property that has since thoroughly researched problems around trusting large networks of counterparties and solved it by making counterparties pay risk premiums. However the adjustments made to how large-scale finance does business, fueled by highly paid quantitative professionals and expensive internal data centers, misses the challenge domain of making decentralized, autonomous systems that tend toward resiliency by design rather than by management.

With the advance of technology and spread of Internet access, the world is becoming more connected and people have access to nearly any information they seek. The number of internet users has been growing exponentially. Today, over 3.8 billion people have internet access, which is over 50% of the world's population, and this number is expected to rise. Over the past 20 years, the creation, and usage of websites has been expanding with widespread access to the internet. The number of websites totaled 1 million in 1997, then reached and maintained at a milestone of 1 billion since 2016.

Another growing trend in the digital world is the development of decentralized trust. Utilizing blockchain technology, payments and/or contracts may be performed via distributed consensus and recorded on a blockchain utilizing different types of tokens. For example, different types of tokens may include security tokens, or asset tokens, utility tokens, or a combination thereof. A blockchain is simply a distributed ledger of all transactions with respect to payments and/or established contracts. Digital coins, or security tokens, such as Bitcoin (BTC) or Ether (ETH) rely on blockchain technology and are much more than a digital currency, but a network of trust that provides the basis for so much more than just currencies. Cryptocurrency, such as BTC or ETH, is a collection of concepts and technologies that form the basis of a digital money ecosystem.

Units of currency, such as BTC or ETH, are used to store and transmit value among users in the BTC or ETH network. The cryptocurrency is entirely virtual and is distributed in a peer-to-peer system. Cryptocurrencies typically consist of: a decentralized peer-to-peer network, a published transaction ledger, such as a blockchain, a set of rules for independent transaction validation and currency issuance, and a mechanism for reaching global decentralized consensus on the valid blockchain (such as Proof-of-Work or Proof-of-Stake), In its simplest form, Blockchain is a data structure on which transactional data which are highly resistant to modification may be stored. As a data structure, blockchain is a form of distributed ledger technology that enables data sharing across a network of individual computers.

Benefits to blockchain technology include:
i) that all of the data and transactions that are on the blockchain are difficult to modify or hack; and
ii) that the data itself is transparent.

### SUMMARY OF THE INVENTION

In mathematics and computer science, graph theory and graph re-write algorithms as fields of study have a rich foundation. Due to a prior lack of overlap between theorists and decentralized derivatives developers, there has yet to exist a rewrite algorithm that can ensure a 0-sum transfer of value across the rewritten graph for a targeted settlement value. The current technology does not resolve the issue, they explored viable algorithms and efficiency heuristics for sorting 0-sum (or any other target sum) subgraphs, but did not take into account any notion of settlement reference price or global target value, and proved inapplicable to solving the problem.

The difference between target value search as a graph theory problem, and the problem tackled by these algorithms, is that target value search imposes sub-graph constraints that are searched for within a larger graph, whereas the algorithm of this invention uses the math principles of target value search at the sub-graph level, but instead of covering the graph it completes the graph based on mathematics that leverages the predictability of a first-in-first-out netting of chains of nodes and the micro-symmetry of atomic pairs of nodes with standardized weight intervals, in order to arrive at a closest-fit settlement value that sums-0 for the entire rewritten graph. The algorithms described herein can be defined as “Target Value Rewrites.”

The family of algorithms described in this patent involve analyzing a set of addresses and trades between them in the form of a graph, deriving a set of ghost nodes to extrapolate or interpolate paths that, net on a zero-sum basis. The basic version of the algorithm uses extrapolation, discovers a zero-sum netting that collapses the entire graph, calculates transfer of value between edge nodes that represent open positions at expiration, with an implied price calculated inferentially. More complex permutations of the algorithm involve imposing an external data feed, calculating a volume-weighted, time-weighted and other derivations from that time series, and targeting a settlement price that enables a 0-sum re-write as close as possible to settlement price suggested by the time series. Further variations enable perpetual contracts that don't expire, but roll participants on an ongoing basis, re-writing the graph to match open nodes to new counterparts where applicable.

To enable resilient, decentralized clearing, the problem of graph asymmetry, which is a bi-product of market chaos, must be solved. The value congruency of different addresses trading decentralized derivatives drifts over time as more trading, and more nodes enter the graph. On the first trade, the entire system is symmetrical, as the number of trades increases, local value congruence drifts. The graph re-write algorithm and its subversions described herein enable the folding-in of these networks to a reliable, deterministic approximation of target value.

### BRIEF DESCRIPTION OF THE DRAWINGS

This disclosure is illustrated by way of example and not by way of limitation in the accompanying figure(s). The figure(s) may, alone or in combination, illustrate one or more embodiments of the disclosure. Elements illustrated in the figure(s) are not necessarily drawn to scale. Reference labels may be repeated among the figures to indicate corresponding or analogous elements.

The detailed description makes reference to the accompanying figures in which:

FIG. 1 is a simplified functional block diagram of a computer system in accordance with the embodiments of the disclosed, invention;

FIG. 2 is simplified example of a distributed ledger in accordance with at least one embodiment of the invention;

FIG. 3 is a block diagram depicting an exemplary environment 300, illustrating a simplified example of how a distributed ledger may be distributed, or replicated, on a network of the disclosed invention;

FIG. 4 illustrates an exemplary distributed ledger in accordance with an embodiment of the disclosed invention;

FIGS. 5A and SB illustrate a flow diagram for the logic and cycles underpinning the graph re-write algorithm for a single-settlement expiring contract;

FIGS. 6A and 6B illustrate a flow diagram for the graph re-write algorithm where periodic settlement governs the contract, whether it be perpetual or of fixed-maturity;

FIG. 7 depicts a cardinal vertex relationships in the graph problem handled by the algorithms, and depicts the mechanics of a local re-write between sub-graphs;

FIG. 8 depicts the factoring of a larger graph into sub-graphs with congruent pairings of weights;

FIG. 9 depicts how separate factored sub-graphs can be connected to resolve imbalances in their target-value weights;

FIG. 10 is an example model blockchain message;

FIG. 11 in example execution of a so-called “smart contract” in compliance with this invention; and

FIGS. 12A-12E are diagrams showing details of example trade channel transactions that may be used by this invention.

### DETAILED DESCRIPTION

The figures and descriptions provided herein, may have been simplified to illustrate aspects that are relevant for a clear understanding of the herein described apparatuses, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, for the sake of brevity a discussion of such elements and operations may not be provided herein. However, the present disclosure is deemed to nevertheless include all such elements, variations, and modifications to the described aspects that would be known to those of ordinary skill in the art.

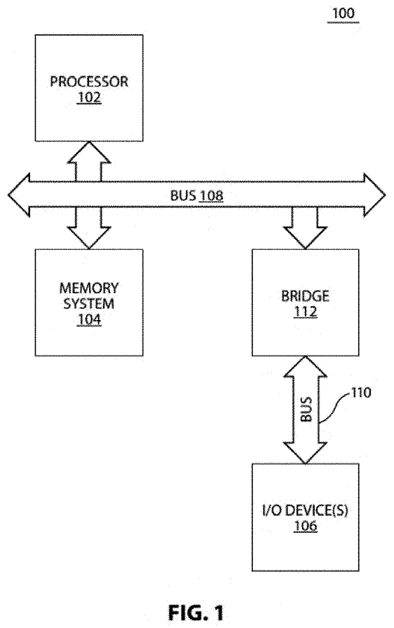

FIG. 1 is an example of a simplified functional block diagram of a computer system 100. The functional descriptions of the present invention can be implemented in hardware, software or some combination thereof.

As shown in FIG. 1, the computer system 100 includes a processor 102, a memory system 104 and one or more input/output (I/O) devices 106 in communication by a communication ‘fabric’. The communication fabric can, be implemented in a variety of ways and may include one or more computer buses 108, 110 and/or bridge and/or router devices 112 as shown in FIG. 1. The I/O devices 106 can include network adapters and/or mass storage devices from which the computer system 100 can send and receive data for generating and transmitting advertisements with endorsements and associated news. The computer system 100 may be in communication with the Internet, via the I/O devices 108.

Those of ordinary skill in the art will recognize that many modifications and variations of the present invention may be implemented without departing from the spirit or scope of the invention. Thus, it is intended that the present invention cover the modification and variations of this invention provided they come within the scope of the appended claims and their equivalents.

The various illustrative logics, logical blocks, modules, and engines, described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of instructions on a machine readable medium and/or computer readable medium.

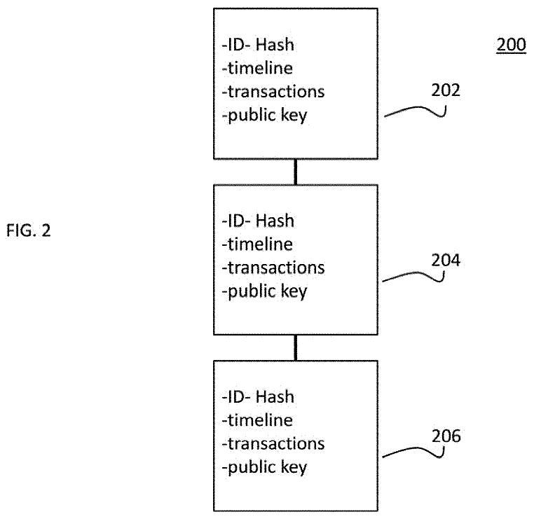

As illustrated in FIG. 2, blockchain 200 is an illustrative example in accordance with at least one embodiment of the invention. Blockchain 200 illustrates a simplified blockchain having 3 blocks, 202, 204, and 206. Block 202 is the first block and is therefore considered to be the genesis block. Each block may include certain information, such as an Identification, or hash, that uniquely identifies the block, a timeline identifying previous blocks (e.g., the hash numbers of previous blocks) in chronological order, transactions to record all transfers between a sender and a receiver, and a public key that identifies at least one sender and at least one receiver. Hash values may be combined into a Merkle tree. The linked blocks therefore form a chain where each link, or block, in the chain uniquely identifies a previous link, or block, by including the hash or the prior link, or block.

In some embodiments of this invention, nodes in the blockchain may represent entities which are seeking to clear settlements through a decentralized clearing house. As shown below, a blockchain message may be configured to store the details of the settlement information in order for a decentralized clearing house to settle through a blockchain network.

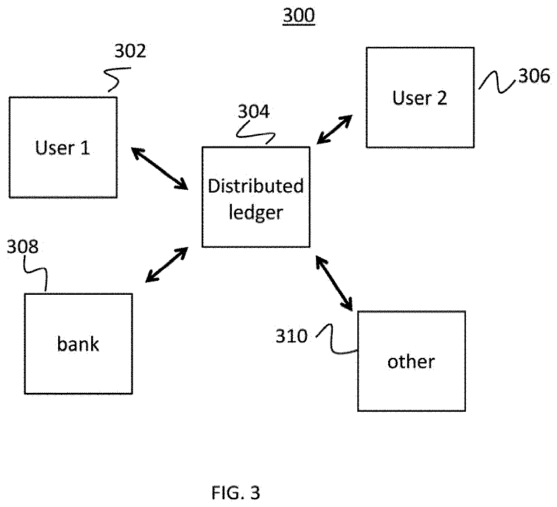

FIG. 3 is a block diagram depicting an example blockchain environment 300, illustrating a simplified example of how a distributed ledger, or blockchain (such as blockchain 200) may be distributed, or replicated, on a network. The distributed ledger may be replicated and maintained on each database within the underlying blockchain's network. Maintenance occurs when consensus is reached between the network's nodes and a new block is added to the chain. Environment 300 may include a first user 302, a second user 304, another entity, such as a bank 308, and another third party entity 310 privy to the blockchain 306, for example a mining node. The first/second user may be a buyer or seller, based on the transaction. Entities may include, but are not limited to, consumers, bankers, merchants, and investors. Blockchain 306 may be replicated in an agreed-upon manner or in real-time (e.g., after each transaction).

In some embodiments of this invention, nodes may represent any entity which is looking to settle through a decentralized clearinghouse. However, sometimes a blockchain network involves only nodes which want to effect settlement clearing and it, might be advantageous to have the blockchain network private. By having the blockchain network private, the clearinghouse and its settlement members may be able to share confidential settlement information via blockchain messages without fear of data breach or other information sharing problems.

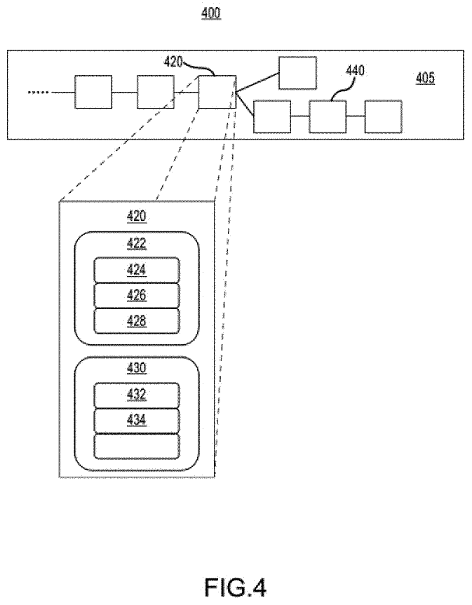

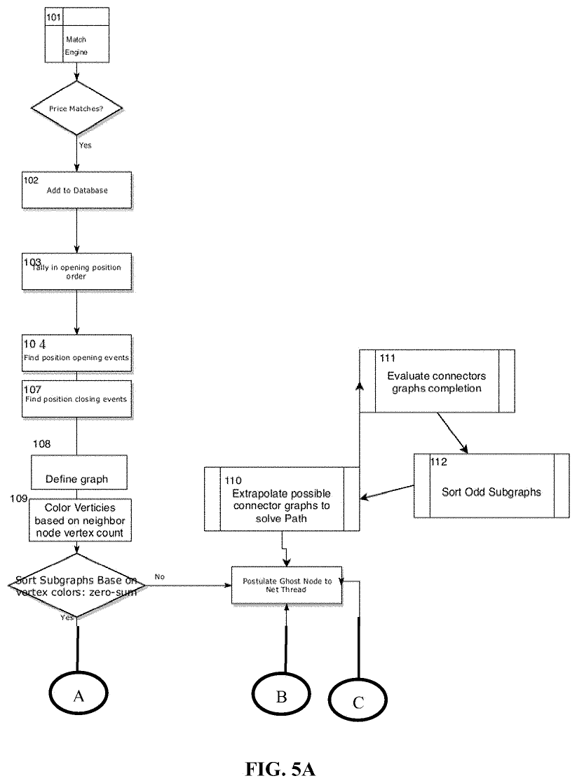

In an embodiment of the present invention, a distributed secure transaction ledger, in the form of a blockchain, may be used to communicate data between parties. As illustrated in FIG. 4, a block chain or decentralized secure transaction ledger 405 may be one that is maintained by nodes in a distributed network. Although each block of ledger 405 may contain differentiated information and may have distinct purposes, as illustrated in FIG. 4, block 420 contains a sample communication or message according to embodiments of the present invention.

In an embodiment of the present, invention, ledger 405 may be used to send messages, or conduct transactions, between at least two users of a system through, for example, nodes in a network. By way of non-limiting example only, a message in block 420 of the ledger 405 may contain a header 422 and contents 430. The header 422 may comprises at least one block ID 424 for block 420, a block ID 426 of the previous block, and a nonce value 428, an arbitrary number that may be used as a cryptographic hash function. These values and block information may be used in linking blocks together to form a chain.

The contents 430 may comprise one or more messages 432 and may also include other data 434. In an embodiment on the present invention, a message 432 may comprise a unique identifier of the owner/originator/sender of the message. This information may be used for one or more purposes, such as, for example, to identify the owner or sender to provide a way by which a third-party node or nodes that handle and or process the ledger 405. Additionally, the identifier of the owner/sender may be used or linked to an authentication module and/or server associated with using the block chain as a communication channel, or for other actions. Indeed, block 420 may include any number of identifiers which may for example, be used to indicate whether or not the ledger 405 should be directed to a different identifier than the originator of the message 432. As would be appreciated by those skilled in the art, message 432 may include data for processing, which may be obfuscated using, for example, homomorphy transformation.

In an embodiment of the present invention, ledger 440 may be used to send encrypted and secure messages between users through public systems, private/closed systems, or a combination thereof. Similar to the message(s) in block 420, the contents of ledger 440 may comprise of one or more messages and may also comprise other encryption/authentication data. In an embodiment of the present invention, a message contained in ledger 440 may comprise of a unique identifier of the recipient of the message, which may be the originator of the initial message or another entity. The message may include a unique identifier of the node that submitted the message. Such may be used for one or more purposes. For example, the identifier may help identify who sent the message. Additionally, the identifier may be used or linked to an authentication server/module associated with using the block chain as a communication channel, for performing security, authentication, resolving, or other actions.

In an embodiment of the present, invention, the message 432 may include a digitally signed message checksum as way to verify the message. For example, the sender of the message may digitally sign a checksum or hash of the message using his or her private key. A receiving device can verify the integrity of the data by verifying the checksum or hash using the sender's public key. Those having skill in the art shall recognize that other methods for verifying the data's integrity may also be employed herein.

Matching events create connections between nodes, by rewriting a graph of all node connections, it's possible to eliminate nodes from the graph that have 2 vertices, and calculate the transformation of the constituent nodes' weightings for a target value T, where every vertex has a given value P, and where the weightings adjust to T-P every time the algorithm executes. The algorithm can infer a target value T based on an emergent path of least resistance of the aggregate match event values, a “natural” target value, and target such a 0-sum value with local approximation to an imposed external value for T. The algorithm can execute with a parameter to eliminate the entire graph and allocate node weights according to T-P in the process of elimination, and it can execute with a parameter where it maintains liveness of remaining node vertices, and transforms them between containers demarcating past-session events and current-session events.

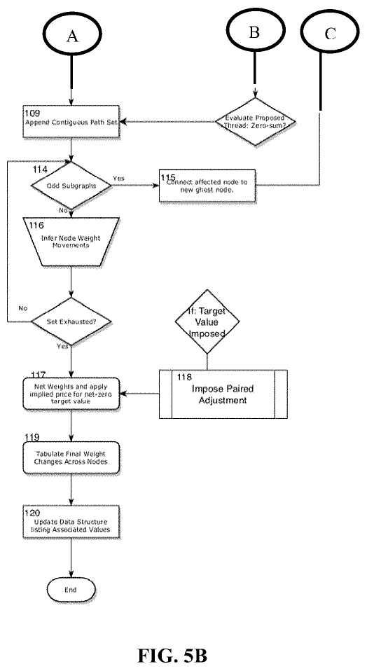

In reference to FIGS. 5A and 5B:

In process block 101, depending on the match logic, first-in, first-out; last-in, first-out, or direct matching, orders are matched. In process block 102, after the matching event is confirmed in the blockchain, it is parsed from the blockchain and added to a database with information about the trade created in process block 101, it adds a new line with both parties identified, the amount transacted and information about the state of the trade, whether it be a mutual position open, a mutual position close or a netting event where one part is reducing position and the other is increasing position. Only information about the trade itself is immutable, the state information is part of the rewriting logic that will be discussed later.

In process block 103, the matches in the database from process block 102 carry an ordering in which they were matched, and when two datasets need to be merged, such as a set of counterparties from a previous re-write, it follows the same ordering of the matching engine in process block 101.

In process block 104, open positions are tagged in the graph creation as orders in which both sides are incrementing their position, adding new vertices and defining edges for path formation. These edges determine the amount of paths in the graph.

In process block 105 (not shown but in sequence after 104), closing events are tagged in the graph creation as orders in which both sides are decreasing their position, and reduce the total netting amount inside a path. The rest of the trades are netting events, in, which a party is closing a position to another increasing theirs, creating the edges in the graph.

In process block 106 (not shown but in sequence after 105), a graph is created from the database in process block 102 in which the nodes are address events, so if the address has two different positions netting it will be two different nodes in different paths. Edges are weighted with the amounts being traded in the match created in process block 101. Edges are directed by netting events. Paths have opening events in process block 104 as a source for path forming, in which each independent side of the opening event nets to other individuals.

In process block 107, if the paths have a net transfer of weight equal to 0, the path is checked for any net unrealized profit or loss, and is added to the final graph or to the ghost node module to determine quantity and placement of connecting sub-graphs needed to complete the path.

Per process block 108 when the path hasn't collapsed by netting all weight in the original edge, this module creates ghost nodes, which is a term of art for connecting sub-graphs that link connects two different paths to net out the weight while maintaining the contiguity of the path. This enforced contiguity of paths ensures consistency in the flow of weight (which can constitute in applied context, profit-and-loss of financial contracts) even if some nodes have insufficient weight (in an applied context this would involve a counterparty being liquidated due to insufficient margin to outweigh their loss, and no other counterparty assuming their position, such as in a very volatile market move—this is the applied innovation whereby this algorithm permits decentralized clearing without a central clearinghouse).

In process block 109 (FIG. 5A), paths get completed with ghost nodes one by one looking at the amount of open contracts. Per process block 110, there is a check if we have zero netted events for UPNL with the ghost nodes every single path. In process block 111, a copy of live nodes is saved to the database with the rewritten vertices.

In process block 109 (FIG. 5B), sub-graphs with odd target values remain, the invention loops through them until a contiguous graph is rewritten. Per process block 114, the invention finds a connector graph to resolve odd sub-graphs. Per process block 115 affected nodes are connected to a new ghost node if there are odd sub-graphs. Per process block 116, the invention infers node weight movements.

In process block 117, weights are netted and an implied price is applied for a net-zero target value. Per process block 118, the invention finds the closest net-0 settlement for imposed target value. In process block 119, the invention tabulates a final weight change across nodes. Finally, in process block 120, the invention updates data structure listing associated values (such as, in an applied context, a ledger mapping balances to various accounts or addresses).

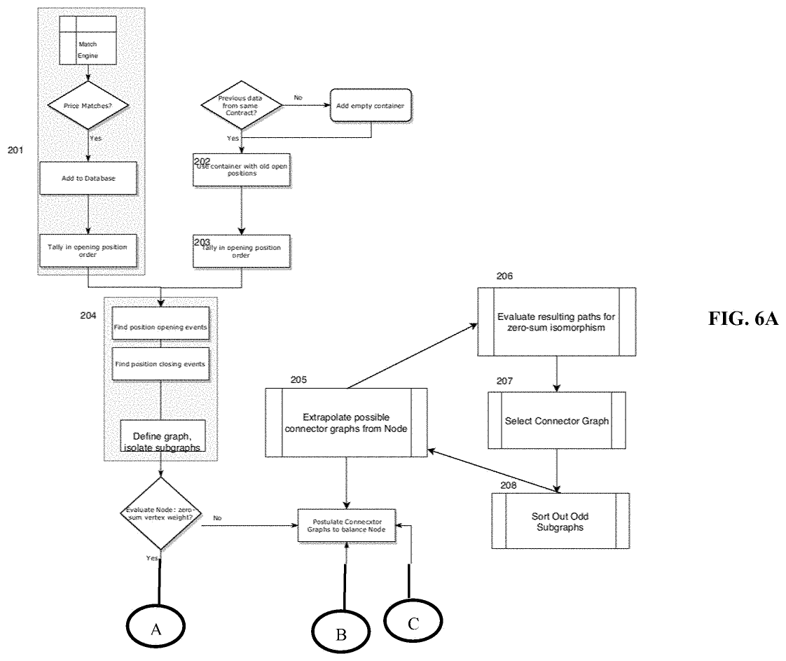

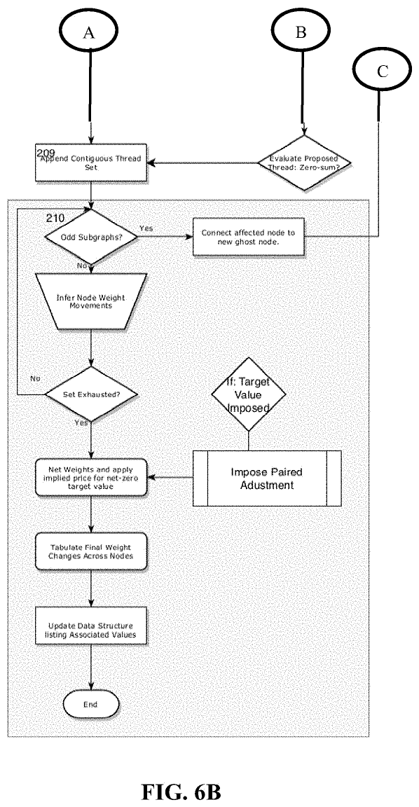

In reference to FIGS. 6A and 6B:

In process block 201, the order matching is identical to the method described in FIGS. 5A and 5B. Per process block 202, a database is used to reference node pairs from previous sessions. In process block 203, netting events connect nodes from earlier sessions to nodes in the live session.

In process block 204, netting and sub-graph sorting is identical to the method described in FIGS. 5A and 5B. Per process block 205, off-setting sub-graphs are extrapolated from individual nodes instead of sorting connections between entire sub-graphs. This is necessary to establish continuity with nodes from earlier sessions.

In process block 206, the invention evaluates connector graphs for imbalance reduction. Per process block 207, the invention selects a connector graph with optimal reduction of imbalances. In process block 208, if all the vertices of a given node can't be reduced to zero-sum paths, sort those sub-graphs out for later connections.

In process block 209, the resulting sub-graphs can reduce to pairs of nodes connected by a collapsed vertex at settlement or be netted out from closed positions where applicable. Finally, per process block 210, the resolution of the rewrite is identical to process in FIGS. 5A and 5B.

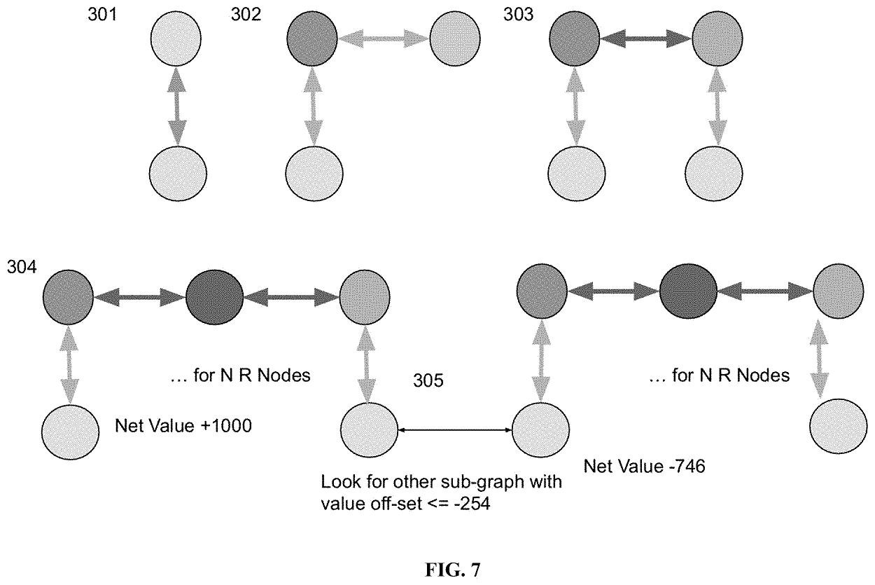

FIG. 7 depicts a cardinal vertex relationships in the graph problem handled by the algorithms, and depicts the mechanics of a local re-write between sub-graphs.

Section 301 represents the first canonical vertex type as two open positions.

Section 302 represents the second canonical vertex type as a netted position against another opening node.

Section 303 represents the third canonical vertex type which is a netting of positions against another node netting positions.

Section 304 represents the fourth canonical vertex type which is a netting of positions against multiple nodes netting positions in a chain of N nodes in length.

Section 305 represents the connector graph sorting subgraphs with various levels of target-value imbalance along their paths and makes a great path that allows for netting between the two, while sorting out odd-remainder subgraphs for further rewriting.

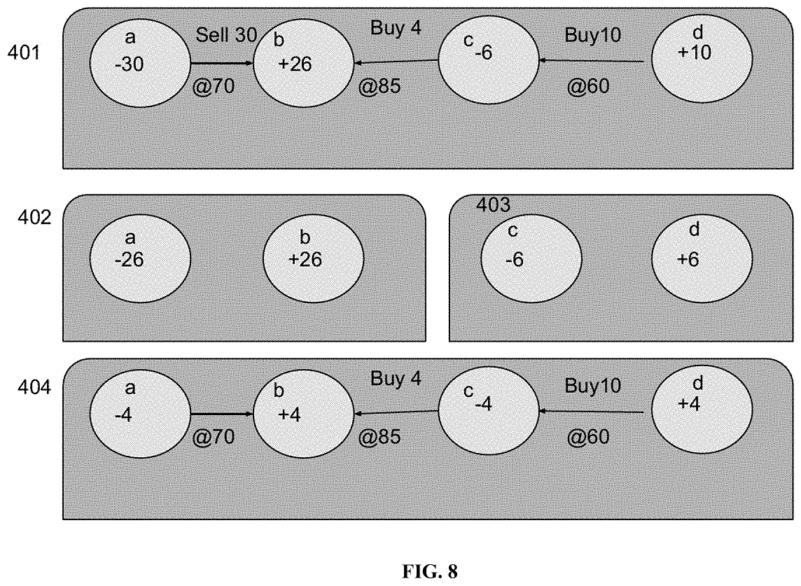

FIG. 8 depicts the factoring of a larger graph into sub-graphs with congruent pairings of weights.

In section 401, there is a vanilla sort where a sub-graph target values all evaluate to 0, starting, with a set of raw vertex connections with random weights at random prices. This graph's complexity is low enough to allow for sorting without making any connector graphs.

Per section 402 the first vertex that is left open, without any off-setting net vertices, are sorted as the original paired vertex during rewrite. A: −26, B: +26; A−B=0.

Per section 403, the other pairing that has a partial vertex that isn't netted leaves its own pairing during rewrite. C: −6, D: +6; A−B=0.

Per section 404, the netted set of nodes and vertices are sorted out as an isomorphic sub-graph based on tracing the sequence of netting vertices where vertex weight (e.g., # of contracts or units traded) is congruent. A: −4 . . . D: +4; A−B=(−100)+(40)+(60)=60 RPNL, 40 UPNL.

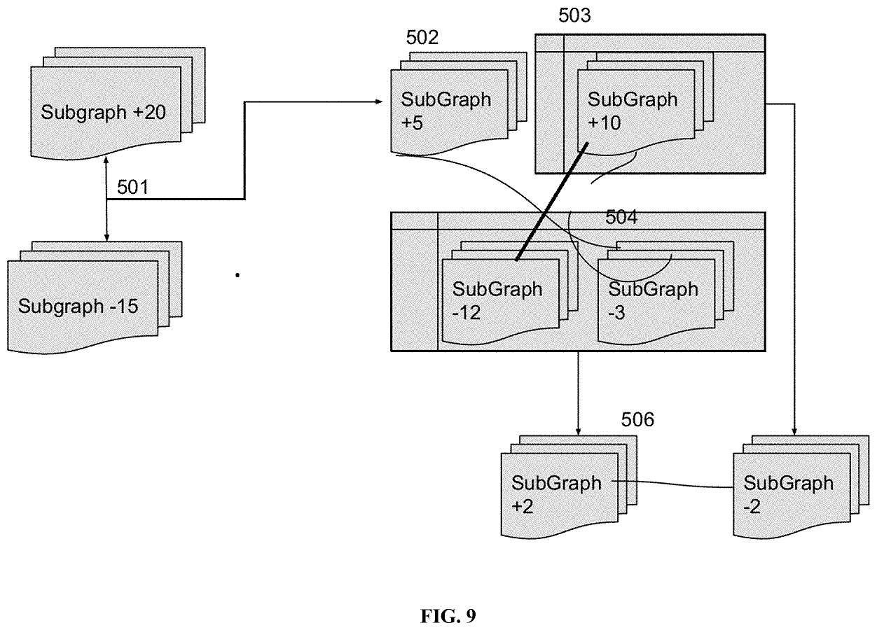

FIG. 9 depicts how separate factored sub-graphs can be connected to resolve imbalances in their target-value weights.

Section 501 represents two sub-graphs that have opposing imbalances, they are connected with the remainder sub-graph being factored out. +20<−>−15: −>+5.

Section 502 represents a sub-graph product that is introduced to a set of odd sub-graphs.

Section 503 represents a larger magnitude sub-graph that is matched to a near magnitude sub-graph based on a closest-magnitude heuristic used improve performance, a −2 sub-graph is produced as a remainder.

Section 504 represents a −3 subgraph that is matched with the +5 sub-graph and factors out a +2 remainder sub-graph.

Finally section 505 represents the remaining odd sub-graphs are matched and eliminated from the pool.

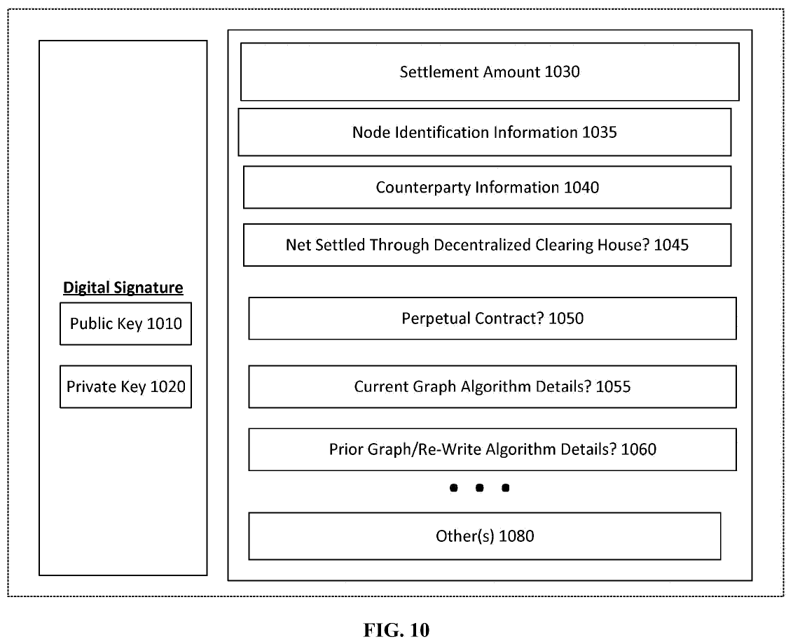

FIG. 10 is an example model blockchain message. Transaction messages are used by the described technology for performing settlement clearing transactions through a decentralized clearinghouse which require the use of the blockchain network.

A transaction message may include a digital signature of the transaction, which has both a shared public key 1010, and a non-shared private key 1020. The transaction through Settlement Amount 1030 stores the settlement amount of the node and/or entity involved on one side of the settlement. Node Identification Information 1035 stores identifying information concerning the node, for example, like if the entity in this transaction is a bank or person and what kind settlements instructions are attached.

Counterparty Information 1040 may represent the counterparty which the node in question, is in a settlement deal with. The details may identify what type of entity the counterparty is, like a person or a shipping company, or the like. Such field may also contain details of how the counterparty wants their side of the deal settled.

Net Settled Through Decentralized Clearing House? 1045 may store whether the node has been net settled through the decentralized clearing house. Once the invention settles a node, this field may be updated with yes, or settled, or the like. This can let the invention know whether or not to process the node, in terms of settlement.

Perpetual Contract? 1050 may store whether the node is involved in settlement deal which is ongoing and not a one-time transaction. This field may notify the invention what kind of graph theory to perform on the node, and on the node's counterparty. Perpetual contracts may require different graph theory algorithms for settlement in the blockchain network which contains the decentralized clearing house.

Current Graph Algorithm Details? 1055 may store the current graph mapping details assigned to the node. For example, the node may have had a prior graph theory applied to it, where there was no zero sum. As such, the current graph theory process may currently attempt to net settle the node using graph theory algorithms to sum to zero.

Prior Graph/Re-Write Algorithm Details? 1060 may store prior graph theory algorithms that were applied to the node. For example, prior graph theory process attempts may have not resulted in a sum zero settlement. As such, the prior graph theories applied to the node may be relevant for analysis of the decentralized clearinghouse. Finally, Other(s) 1080 may store any other message information which may be relevant to the invention herein.

From a blockchain decryption standpoint, the network nodes decrypt the digital signature, via the sender's previously exchanged public key, and compare the unencrypted information to the transaction. If they match, the sender's authenticity is verified and, wherein the receiving entity, or settlement node counterparty, shall proceed to carry out the settlement transaction through blockchain tools like smart contracts, and the like. The receiving entity can be any other entity which is a counterparty to the current node being processed.

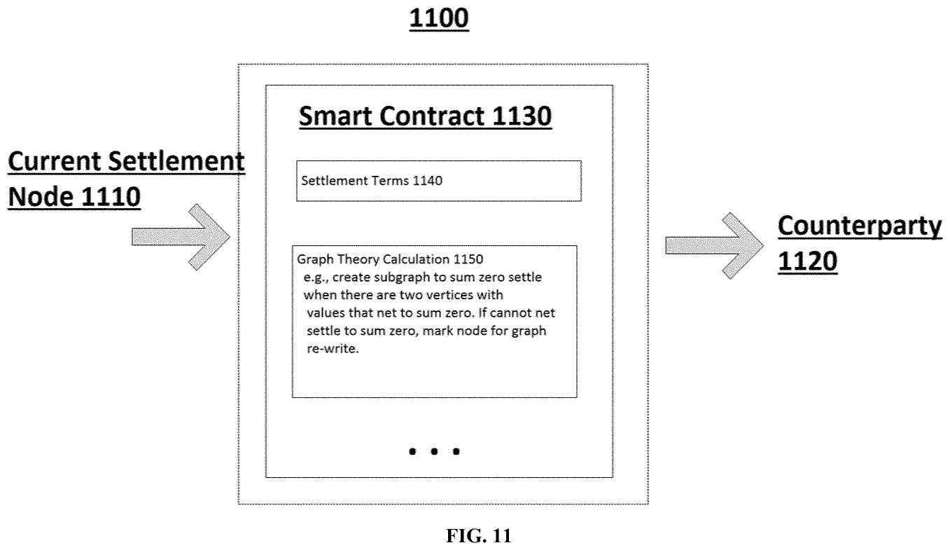

FIG. 11 in example execution of a so-called “smart contract” in compliance with this invention. Smart contracts may store all the graph theory algorithms discussed in this disclosure. These algorithms may be initiated to effect settlement based on conditions met by node properties of settlement parties. The smart contracts themselves may modify and change data on blockchain messages such as the model message in FIG. 10.

1100 represent an example so-called “smart contract,” or the like, which executes code on a blockchain network based on a certain condition matching. 1110 represents the current node being evaluated by the blockchain network which has settlement details against a counterparty 1120. Smart Contract 1130 may represent a mechanism stored on the blockchain which triggers code when a condition(s) is met.

Settlement Terms 1140 may represent the settlement details the current node has with its counterparty. Graph Theory Calculation 1150 may represent code which is triggered when a condition is met. For example, the coding may create a subgraph to sum zero settle when there are two vertices with values that net to sum zero. If the two parties cannot net settle to sum zero, the coding may mark node for graph re-write to net settle in another graph theory algorithm process.

In an example embodiment of this disclosure, all the graph theory algorithms disclosed in this document may be coded on smart contracts which will effect settlement on a decentralized clearing house.

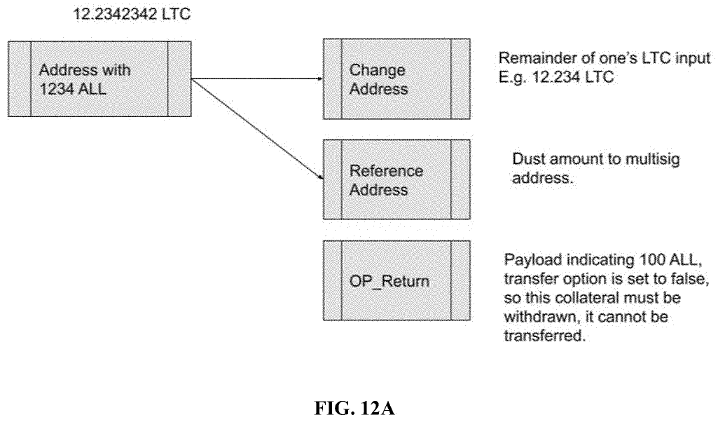

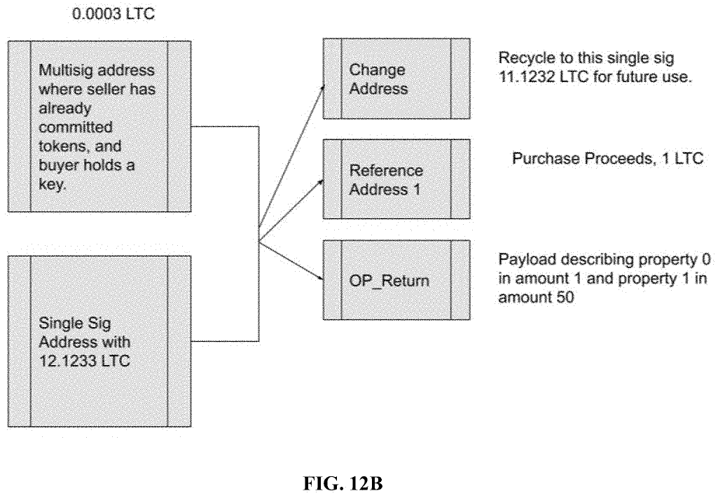

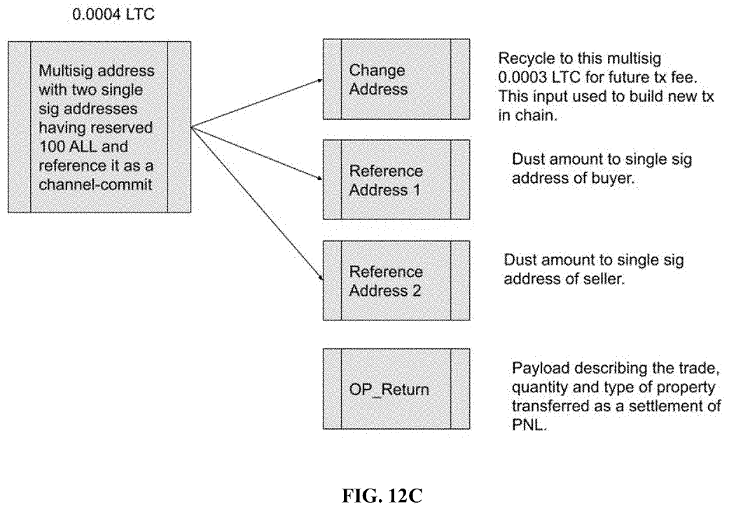

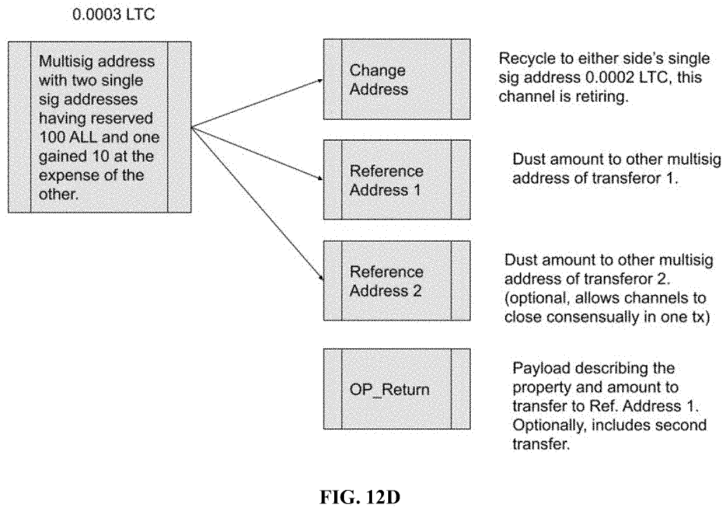

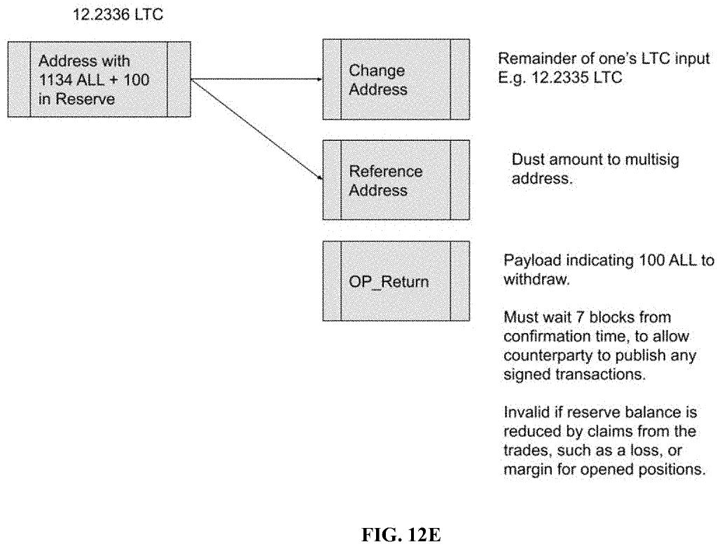

FIGS. 12A-12E are diagrams showing details of example trade channel transactions that may be used by this invention. All the transaction types in the protocol use an OP Return output that embeds the relevant, transaction data. The software client is an alternative to Bitcoin or Litecoin core that parses these OP Returns in confirmed transactions and collates them into data structures such as a map of properties, or the resulting update after a settlement block, where a clearing algorithm (sample code shown below) is applied for sorting purposes.

It is appreciated that exemplary computing system 100 is merely illustrative of a computing environment in which the herein described systems and methods may operate, and thus does not limit the implementation of the herein described systems and methods in computing environments having differing components and configurations. That is, the inventive concepts described herein may be implemented in various computing environments using various components and configurations.

Below is example code which may be used by the invention to initiate a transaction line for a node to settle in the decentralized clearing house. For example, when a party wants to effect settlement with a counterparty, it may utilize the code below to post a blockchain message requesting clearing of a transaction through a decentralized clearing house on a blockchain. In time, this message would be settled through a graph theory algorithm(s).

```
#include
″tradelayer/createtx.h″
  #include ″tradelayer/encoding.h″
  #include ″tradelayer/script.h″
  #include ″base58.h″
  #include ″coins.h″
  #include ″primitives/transaction.h″
  #include ″pubkey.h″
  #include ″script/script.h″
  #include ″script/standard.h″
  #include ″uint256.h″
  #include <stdint.h>
  #include <string>
  #include <utility>
  #include <vector>
  /** Creates a new previous output entry. */
  PrevTxsEntry::PrevTxsEntry(const uint256& txid, uint32_t nOut,
  int64_t nValue, const CScript& scriptPubKey)
    : outPoint(txid, nOut), txOut(nValue, scriptPubKey)
  {
  }
  /** Creates a new transaction builder. */
  TxBuilder::TxBuilder( )
  {
  }
  /** Creates a new transaction builder to extend a transaction. */
  TxBuilder::TxBuilder(const CMutableTransaction& transactionIn)
    : transaction(transactionIn)
  {
  }
  /** Adds an outpoint as input to the transaction. */
  TxBuilder& TxBuilder::addInput(const COutPoint& outPoint)
  {
      CTxIn txIn(outPoint);
      transaction.vin.push_back(txIn);
      return *this;
  }
  /** Adds a transaction input to the transaction. */
  TxBuilder& TxBuilder::addInput(const uint256& txid, uint32_t nOut)
  {
      COutPoint outPoint(txid, nOut);
      return addInput(outPoint);
  }
  /** Adds an output to the transaction. */
  TxBuilder& TxBuilder::addOutput(const CScript& scriptPubKey, int64_t
  value)
  {
      CTxOut txOutput(CAmount(value), scriptPubKey);
      transaction.vout.push_back(txOutput);
      return *this;
  }
  /** Adds a collection of outputs to the transaction. */
  TxBuilder& TxBuilder::addOutputs(const
  std::vector<std::pair<CScript, int64_t> >& txOutputs)
  {
      for (std::vector<std::pair<CScript, int64_t> >::const_iterator
  it = txOutputs.begin( );
          it != txOutputs.end( ); ++it) {
        addOutput(it->first, it->second);
      }
      return *this;
  }
  /** Adds an output for change. */
  TxBuilder& TxBuilder::addChange(const CTxDestination& destination,
  const CCoinsViewCache& view, int64_t txFee, uint32_t position)
  {
      CTransactiob tx(transaction);
      if (!view.HaveInputs(tx)) {
        return *this;
      }
      CScript scriptPubKey = GetScriptForDestination(destination);
      int64_t txChange = view.GetValueIn(tx) - tx.GetValueOut( ) -
  txFee;
      int64_t minValue = GetDustThld(scriptPubKey);
      if (txChange < minValue) {
        return *this;
      }
      std::vector<CTxOut>::iterator it = transaction.vout.end( );
      if (position < transaction.vout.size( )) {
        it = transaction.vout.begin( ) + position;
      }
      CTxOut txOutput(txChange, scriptPubKey);
      transaction.vout.insert(it, txOutput);
      return *this;
  }
  /** Returns the created transaction. */
  CMutableTransaction TxBuilder::build( )
  {
      return transaction;
  }
  /** Creates a new Trade Layer transaction builder. */
  TLTxBuilder::TLTxBuilder( )
    : TxBuilder( )
  {
  }
  /** Creates a new Trade Layer transaction builder to extend a
  transaction. */
  TLTxBuilder::TLTxBuilder(const CMutableTransaction& transactionIn)
    : TxBuilder(transactionIn)
  {
  }
  /** Adds a collection of previous outputs as inputs to the
  transaction. */
  TLTxBuilder& TLTxBuilder::addInputs(const std::vector<
  PrevTxsEntry>&
  prevTxs)
  {
      for (std::vector<PrevTxsEntry>::const_iterator it =
  prevTxs. begin( );
          it != prevTxs.end( ); ++it) {
        addInput(it->outPoint);
      }
      return *this;
  }
  /** Adds an output for the reference address. */
  TLTxBuilder& TLTxBuilder::addReference(const std::string&
  destination, int64_t value)
  {
      CTxDestination address = DecodeDestination(destination);
      CScript scriptPubKey = GetScriptForDestination(address);
      int64_t minValue = GetDustThld(scriptPubKey);
      value = std::max(minValue, value);
      return (TLTxBuilder&) TxBuilder::addOutput(scriptPubKey, value);
  }
  /** Embeds a payload with class D (op-return) encoding. */
  TLTxBuilder& TLTxBuilder::addOpReturn(const std::vector<unsigned
  char>& data)
  {
      std::vector<std::pair<CScript, int64_t> > outputs;
      if (!TradeLayer_Encode_ClassD(data, outputs)) {
        return *this;
      }
      return (TLTxBuilder&) TxBuilder::addOutputs(outputs);
  }
  /** Adds an output for change. */
  TLTxBuilder& TLTxBuilder::addChange(const std::string& destination,
  const CCoinsViewCache& view, int64_t txFee, uint32_t position)
  {
      CTxDestination addr = DecodeDestination(destination);
      return (TLTxBuilder&) TxBuilder::addChange(addr, view, txFee,
  position),
  }
  /** Adds previous transaction outputs to coins view. */
  void InputsToView(const std::vector<PrevTxsEntry>& prevTxs,
  CCoinsViewCache& view)
  {
      for (std::vector<PrevTxsEntry>::const_iterator it =
  prevTxs.begin( ); it != prevTxs.end( ); ++it)
      {
          const Coin alreadyCoin = AccessByTxid(view) it-
  >outPoint.hash);
        Coin newCoin(it->txOut, alreadyCoin.GetHeight( ),
  alreadyCoin.IsCoinBase( ));
          view.AddCoin(it->outPoint, std::move(newCoin), false);
      }
  }
```

Below is example code which the invention may to perform the graph theory algorithm analysis. For example, once settlement messages are posted to the blockchain network via nodes, a smart contract may utilize the below code to find unsettled nodes and use a graph theory algorithm (one of the ones disclosed in this invention) and net settle nodes through a decentralized clearing house.

Those of skill in the art will appreciate that the herein described apparatuses, engines, devices, systems and methods are susceptible to various modifications and alternative constructions. There is no intention to limit the scope of the invention to the specific constructions described herein. Rather, the herein described systems and methods are intended to cover all modifications, alternative constructions, and equivalents falling within the scope and spirit of the disclosure, any appended claims and any equivalents thereto.

In the foregoing detailed description, it may be that various features are grouped together in individual embodiments for the purpose of brevity in the disclosure. This method of disclosure is not to be interpreted as reflecting an intention that any subsequently claimed embodiments require more features than are expressly recited.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed herein.

1. A non-transitory computer readable storage medium communicatively coupled to one or more processors and configured to store executable computer instructions when executed, to cause the one or more processors, to perform operations comprising:
receiving, from nodes of a blockchain network, matching requests, wherein one matching request represents at least two different nodes in a blockchain which want to net settle at least financial derivatives between each other;
drawing, using the nodes from the blockchain network, a first graph of vertices and edges wherein one vertex is associated with one node of a matching request, and each edge connects two vertexes;
drawing, using the first graph, a plurality of subsidiary graphs, of vertices and edges, wherein the subsidiary graphs' vertices offer alternative netting settlement paths which differ from the first graph;
determining, the vertices which can match each other and create a zero sum transfer to be net settled;
marking, the net settled vertices to not be net settled again, on a subsequent graph re-drawing;
redrawing and, recalculating, the first graph and the subsidiary graphs, known as a graph re-write, until all vertices are net settled.

2. The non-transitory computer readable storage medium of claim 1, wherein the logic of the matching requests can be first-in first-out, last-in first-out, or direct matching.

3. The non-transitory computer readable storage medium of claim 1, wherein the value of one vertex is equal to a value of P and each node receives weighting of a target value T is inferred based on an emergent path of least resistance of the aggregate match event values.

4. The non-transitory computer readable storage medium of claim 3, wherein the node weightings adjust to T minus P every time the first graph, and subsidiary graphs, re-executes.

5. The non-transitory computer readable storage medium of claim 1, wherein the different sub-graphs are connected to different paths to net out weights while maintaining a continuity of paths between the first graph and the subsidiary graphs.

6. The non-transitory computer readable storage medium of claim 3, wherein the graph re-write can execute with a parameter to eliminate the entire graph and allocate node weights according to T minus P in the process of elimination.

7. The non-transitory computer readable storage medium of claim 1, wherein the graph re-write can execute with a parameter where it maintains liveness of remaining node vertices, and transforms the nodes between containers demarcating past-session events and current-session events.

8. A system, comprising:
a memory that stores computer executable components; and
a processor that executes the computer executable components stored in the memory, wherein the computer executable components comprise:
at least one component that:
receives matching requests from nodes of a blockchain network, wherein one matching request represents at least two different nodes in a blockchain which want to net settle at least financial derivatives between each other;
draws using the nodes from the blockchain network, a first graph of vertices and edges, wherein one vertex is associated with one node of a matching request, and each edge connects two vertexes;
draws using the first graph, a plurality of subsidiary graphs, of vertices and edges, wherein the subsidiary graphs' vertices offer alternative netting settlement paths which differ from the first graph;
determines the vertices which can match each other and create a zero sum transfer to be net settled;
marks the net settled vertices to not be net settled again, on a subsequent graph re-drawing;
redraws and recalculates the first graph and the subsidiary graphs, known as a graph re-write, until all vertices are net settled.

9. The system of claim 8, wherein the logic of the matching requests can be first-in first-out, last-in first-out, or direct matching.

10. The system of claim 8, wherein the value of one vertex is equal to a value of P and each node receives weighting of a target value T based on an emergent path of least resistance of aggregate match event values.

11. The system of claim 10, wherein the node weightings adjust to T minus P every time the first graph, and subsidiary graphs, re-executes.

12. The system of claim 8, wherein the different sub-graphs are connected to different paths to net out weights while maintaining a continuity of paths between the first graph and the subsidiary graphs.

13. The system of claim 10, wherein the graph re-write can execute with a parameter to eliminate the entire graph and allocate node weights according to T minus P in the process of elimination.

14. The system of claim 8, wherein the graph re-write can execute with a parameter where it maintains liveness of remaining node vertices, and transforms the nodes between containers demarcating past-session events and current-session events.

15. A computer implemented method, comprising:
receiving, from nodes of a blockchain network, matching requests, wherein the matching requests represent at least two different nodes in a blockchain which want to net settle at least financial derivatives between each other;
drawing, using the nodes from the blockchain network, a first graph of vertices and edges wherein one vertex is associated with one node of a matching request, and each edge connects two vertexes;
drawing, using the first graph, a plurality of subsidiary graphs, of vertices and edges, wherein the subsidiary graphs' vertices offer alternative netting settlement paths which differ from the first graph;
connecting, the different sub-graphs to different paths to net out weights while maintaining a continuity of paths between the first graph and the subsidiary graphs;
determining, the vertices which can match each other and create a zero sum transfer to be net settled;
marking, the net settled vertices to not be net settled again, on a subsequent graph re-drawing;
redrawing and, recalculating, the first graph and the subsidiary graphs, known as a graph re-write, until all vertices are net settled.

16. The computer implemented method of claim 15, wherein the logic of the matching requests can be first-in first-out, last-in first-out, or direct matching.

17. The computer implemented method of claim 15, wherein the value of one vertex is equal to a value of P and each node receives weighting of a target value T based on an emergent path of least resistance of aggregate match event values.

18. The computer implemented method of claim 17, wherein the node weightings adjust to T minus P every time the first graph, and subsidiary graphs, re-executes.

19. The computer implemented method of claim 15, wherein the different sub-graphs are connected to different paths to net out weights while maintaining a continuity of paths between the first graph and the subsidiary graphs

20. The computer implemented method of claim 17, wherein the graph re-write can execute with a parameter to eliminate the entire graph and allocate node weights according to T minus P in the process of elimination.
